(19) United States
(12) Patent Application Publication
(10) Pub. No.: US 2004/0130150 A1
(43) Pub. Date: Jul. 8, 2004

(54) Swivel device for hoses

(76) Inventor: David George Stark, Te Awamutu (NZ)

Correspondence Address: YOUNG & THOMPSON, 745 SOUTH 23RD STREET 2ND FLOOR, ARLINGTON, VA, 22202

(21) Appl. No.: 10/471,833

(22) PCT Filed: Mar. 14, 2002
(86) PCT No.: PCT/NZ02/00034

(30) Foreign Application Priority Data
Mar. 15, 2001 (NZ) 510557
Sep. 20, 2001 (NZ) 514313

(51) Int. Cl. F16L 27/00

(52) U.S. Cl. 285/272; 285/278

(57) ABSTRACT

The present invention is directed to a swivel device to be fitted to a hose. The preferred use of the invention is to allow hoses fitted at each end to rotate relative to the other to avoid kinking, and associated problems. Considerations include allowing free rotation of the respective hose sections, while avoiding leaking at the swivel, at pressures typical of mains pressure water supplies, and/or higher. Discussion is made regarding the connection of components to allow swivelling and variations for connecting hoses to the tail piece.

### TECHNICAL FIELD OF INVENTION

The present invention is directed to a swivel device to be fitted to a hose. The preferred use of the invention is to allow hoses fitted at each end to rotate relative to the other to avoid kinking, and associated problems. Considerations include allowing free rotation of the respective hose sections, while avoiding leaking at the swivel, at pressures typical of mains pressure water supplies, and/or higher. Uses include all fluid systems, including water, solvent, hydraulic, pneumatic, air supply and vacuum systems.

### BACKGROUND ART

While the present invention may find use as a connector of lengths of hose, its primary function is a swivel device to allow adjacent sections of hose to rotate relative to the other. Its primary role is not envisaged as being quickly releasable hose connector of the type of many on the market, and thus its design considerations are substantially different. It is with this application in mind that the present invention has been developed, and upon which the present description will focus.

Connectors for hoses exist although their main function is different from the present invention. The primary function of a connector is to connect lengths of hose, and little consideration is given to factors other than being able to connect a hose end to the connecting device. Many hose connectors comprise a single piece, often formed by moulding, and which often consist of little more than a hollow cylindrical tube over which the ends of each hose section can be slid. Often these are used for extending the length of hoses where each section is insufficient in length.

The other type of connector commonly used is a releasable connector. Examples of these include those of the type described in U.S. Pat. No. 5,048,875, and those of the type manufactured and patented by Gardena for domestic use. However, the primary requirement and function of these types of releasable connectors is for easy and rapid disconnection and reconnection by a user. In practice their design is such that joined sections cannot readily and freely rotate relative to the other. While some rotation is possible, there is generally some resistance to rotation which precludes the device working effectively as a swivel device (along the lines of the present invention). Furthermore, this resistance to rotation often increases as the internal fluid pressure also increases. In these types of design the O-ring seal is prone to failure and premature leaking under some circumstances.

A further type of connector are those such as described in U.S. Pat. No. 5,826,920 and U.S. Pat. No. 5,775,738. These are devices which are designed to operate at very high pressures, are complicated in construction, and include quite a number of individual components. Such devices tend to be expensive, difficult to assemble, and are often unsuitable for an outside or dirty environment. In many respects these may be considered to be significantly over-engineered for the intended purpose of the present invention and, similarly to other connectors, are not designed to be able to freely rotate each section of connected hose.

To address the need for a swivel the applicants have previously sought to patent a swivel device under specification WO 01/01031. This is a three piece design including two connecting portions with overlapping sleeve portions and an intermediate locking element.

In practice however, while this design has been found adequate for connecting flexible hoses of larger diameters (typically 20 mm diameter or greater) its construction does have limitations for hoses whose diameters are at the smaller end of the range. For smaller diameters (typically 30 mm or less) the inclusion of a third locking member becomes potentially problematic. As the device is scaled down, each individual portion which overlaps in the centre of the device (i.e. the inner and outer sleeve portions and the locking element) also potentially becomes thinner and more delicate. If wall thicknesses are retained then the device has a potential to become overly bulky. Accordingly there is a need for a swivel device which addresses these potential limitations.

Also considered by the applicants is the manner by which each hose section is affixed to the device. The tail pieces on the applicant's previous design, while similar to many connecting devices, generally require a hose clamp to secure the end of the hose to the tail piece. Depending upon the design of the clamp, many jut out from the surface of the hose and have sharp edge portions. These portions can prevent free rotation by resisting rotation when they contact the ground. When used outside (such as on lawn or other soft ground) these clamped portions can also dig into the ground, or catch on other objects preventing free rotation or dragging of the assembly along the ground. The applicants have also considered this and sought to address this in their embodiments of hose connectors and swivels.

Also for smaller diameters, most hose clamps do not evenly bear against the outer surface of the hose. The result is leaking around the join.

It is therefore one object of the present invention to consider and/or address the foregoing problems. One object of the present invention is to seek to provide an improved or alternative design to that disclosed in previous published specification WO 01/01031A, and which is suitable for use with hoses of smaller diameter.

It is also an object of the present invention to consider alternatives to the use of external hose clamps or separate nuts for securing hoses to connectors, and swivels of the present invention.

At the very least it is an object to provide the public with an alternative to what is already known.

### DISCLOSURE OF THE INVENTION

According to one aspect of the present invention there is provided a swivel including first and second parts, each possessing a tail portion for the connection of a hose, and each part also possessing substantially distal to the tail portion a sleeve portion; the sleeve portion of said first part being an inner sleeve interacting in a male-to-female relationship with the sleeve portion of said second part which acts as an outer sleeve; and when said sleeve portions are engaged the outer surface of said inner sleeve being substantially co-extensive and in intimate relationship with the inner surface of said outer sleeve; said sleeves being able to rotate freely with respect to each other about their longitudinal co-axis; said surfaces being configured to interact with each other to resist longitudinal separation.

According to a further aspect of the present invention there is provided a swivel, substantially as described above, in which the co-extensive sleeve surfaces are profiled to include complementary ridges and grooves which resist longitudinal sliding of one sleeve portion with respect to the other.

According to a further aspect of the present invention there is provided a swivel, substantially as described above, in which the complementary ridges and grooves are configured to allow each sleeve portion to be forced longitudinally in a first direction allowing assembly of the two parts.

According to a further aspect of the present invention there is provided a swivel, substantially as described above, in which when assembled, the swivel resists leaking of fluid from the sleeve portions.

According to a further aspect of the present invention there is provided a swivel, substantially as described above, in which the swivel is resistant to leakage from the sleeve area for water at pressures of up to 300 kPa, and preferably at least 700 kPa.

According to a further aspect of the present invention there is provided a swivel, substantially as described above, which also includes at least one seal member.

According to a further aspect of the present invention there is provided a swivel, substantially as described above, in which a said seal member is an O-ring.

According to a further aspect of the present invention there is provided a swivel, substantially as described above, in which in the assembled swivel the hollow portions define a bore for the flow of fluid through the swivel.

According to a further aspect of the present invention there is provided a swivel, substantially as described above, in which the internal bore is substantially straight.

According to a further aspect of the present invention there is provided a swivel, substantially as described above, in which the tail portions are directed substantially longitudinally.

According to a further aspect of the present invention there is provided a swivel, substantially as described above, in which a tail portion consists of a substantially cylindrical portion which is configured on its outside to resist sliding movement of a hose thereabout, in at least one longitudinal direction.

According to a further aspect of the present invention there is provided a swivel, substantially as described above, in which cylindrical portion is substantially smooth over the majority of its outer surface.

According to a further aspect of the present invention there is provided a swivel, substantially as described above, in which the substantially cylindrical portion includes ridges, and which ridges may be barbs preferably of shallow incline and height.

According to a further aspect of the present invention there is provided a swivel, substantially as described above, in which the ridges are profiled to assist sliding of a hose over the outside of the cylindrical portion in one direction, but resist sliding in the opposite outward direction.

According to a further aspect of the present invention there is provided a swivel, substantially as described above, in which the outside of the substantially cylindrical portion is threaded.

According to a further aspect of the present invention there is provided a swivel, substantially as described above, in which the outside of the substantially cylindrical portion also includes ridges and/or barbs resisting rotation of a hose with respect to the cylindrical portion in one direction, said rotational direction being that of unscrewing of the hose from the cylindrical portion.

According to a further aspect of the present invention there is provided a swivel, substantially as described above, in which the part on which a substantially cylindrical portion is located includes an outer sheath for the end of an attached hose, the inner surface of said sheath being radially distanced from the outer surface of said cylindrical portion, said distance being commensurate with the wall thickness of a typical hose to be connected.

According to a further aspect of the present invention there is provided a swivel, substantially as described above, in which said radial distance between the sheath and cylindrical portion diminishes as one travels inwardly along the tail portion towards the sleeve portion.

According to a further aspect of the present invention there is provided a swivel, substantially as described above, in which the inside of the sheath portion is threaded.

According to a further aspect of the present invention there is provided a swivel, substantially as described above, in which for an internally threaded sheath portion, the outside of the substantially cylindrical portion includes ridges and/or barbs resisting rotation of a hose with respect to the cylindrical portion in one direction, said rotational direction being that of unscrewing of the hose from the cylindrical portion.

According to a further aspect of the present invention there is provided a swivel, substantially as described above, in which for an externally threaded cylindrical portion, the inside of the sheath portion includes ridges and/or barbs resisting rotation of a hose with respect to the cylindrical portion in one direction, said rotational direction being that of unscrewing of the hose from the tail portion.

According to a further aspect of the present invention there is provided a swivel, substantially as described above, in which both sheath (where present) and cylindrical portion include ridges, barbs and/or protuberances resisting removal of a hose from a tail portion once connected.

According to a further aspect of the present invention there is provided a swivel, substantially as described above, in which the sleeve portion of a least one of the parts substantially has radial symmetry about substantially all points along the longitudinal axis of the sleeve portion.

According to a further aspect of the present invention there is provided a swivel, substantially as described above, in which the wall thickness of the sleeve portion of at least the first part, including the inner sleeve portion, is sufficient to resist any flexing in a radial direction.

According to a further aspect of the present invention there is provided a swivel, substantially as described above, in which the wall thickness of the outer sleeve, of the second part, in combination with the positioning of complementary ridges and grooves, and material of construction, is such that there is sufficient flexure and/or resilience to allow the outer sleeve to be slid over the inner sleeve for assembly.

According to a further aspect of the present invention there is provided a swivel, substantially as described above, in which at least one of the parts is fabricated substantially of a plastics material.

According to a further aspect of the present invention there is provided a swivel, substantially as described above, in which said plastics material possesses at least one of the following properties: UV-resistant, non-brittle, of high tensile strength (to resist any flexing more than necessary for assembly), and rigidity.

According to a further aspect of the present invention there is provided a swivel, substantially as described above, in which at least one of the two parts is fabricated by injection moulding.

According to a further aspect of the present invention there is provided a swivel, substantially as described above, in which a tail portion is configured to allow connection of a hose or conduit at an angle to the main longitudinal axis of the swivel.

According to a further aspect of the present invention there is provided a swivel, substantially as described above, in which the angle is substantially perpendicular to the main longitudinal axis of the swivel.

According to a further aspect of the present invention there is provided a swivel, substantially as described above, in which either said first or second part is configured to allow connection of more than one hose or conduit thereto.

According to a further aspect of the present invention there is provided a swivel, substantially as described above, in which said hoses or conduits are configured, when attached, in substantially a ‘Y’ or ‘T’ arrangement with the body of the swivel.

According to a further aspect of the present invention there is provided a swivel, substantially as described above, in which the configurations of the tail portions of the first and second parts, with respect to either or both the number and angle of inclination of connected hoses or conduits, are different.

According to another aspect of the present invention there is provided a swivel comprising at least a first part and a second part; said first part comprising substantially a hollow cylindrical length, one end comprising a tail portion configured to accept the end of a hose for connection, and the other comprising an inner sleeve portion acting as the male member in a male-female connection relationship, the second part comprising also a substantially hollow cylindrical length in which one end comprises also a tail portion, but wherein the other comprises an outer sleeve portion acting as the female member in a male-female connection relationship, wherein upon assembly the inside of the female sleeve is in close intimate relationship with the outside of the male sleeve portion, the two sleeve portions being able to freely rotate with respect to each other, though include complementary profiling to resist longitudinal separation due to internal fluid pressure.

According to a further aspect of the present invention there is provided a swivel, substantially as described above in which an internal bore defined by the hollow internal portions for the flow of fluid is of substantially constant cross-section.

According to another aspect of the present invention there is provided a component consisting of said first part, or second part, or part thereof for use in the assembly of a swivel substantially as described above.

According to another aspect of the present invention there is provided a component, substantially as described above, in which the tail portion allows for either or both of: (i) attachment of a hose or conduit at an angle to the main longitudinal axis of the assembled swivel, and (ii) attachment of multiple hoses or conduits at an end of the assembled swivel.

According to another aspect of the present invention there is provided a component, substantially as described above, which is separable into further subcomponents at least one of which includes a tail portion for the connection of a hose or conduit.

According to another aspect of the present invention there is provided a hose and swivel combination consisting of hoses connected to a swivel substantially as described above.

According to another aspect of the present invention there is provided a method for reducing the tendency of flexible hoses to kink consisting of inserting at least one swivel, substantially as described above, into a length of said flexible hose.

The present invention is directed to a swivel device for allowing portions of hose to rotate relative to each other. Typically, while not strictly intended as solely a connector, the swivel will be seen to rotatably connect sections of hose or other flexible conduit etc. Typically the hose will be used for conveying a fluid or fluidised material. While the present invention may find use as a connector, in which case it would provide the additional function of allowing of the adjacent sections of hose to rotate one to the other, its primary function is as a swivel. In some ways this distinction can be exemplified by considering that a connector is generally used to extend the total length of a series of hoses while in the present invention a single length of hose may be cut into several smaller sections which are each re-joined using swivels of the present invention.

One aim of the present invention is to avoid kinking and twisting which may occur along single lengths of hose and, particularly hoses of softer material. Typically, the present invention will find use where sections of hose are constantly moved, dragged along the ground, or laid out and frequently rolled up.

Typical applications include as a swivel for domestic garden hoses, and hoses in industry such as commonly used for washing down factory equipment, dairy sheds, and the like. It is also envisaged that the present invention may find use for air lines where compressed air is used although typically the design may need to be up-rated for such higher pressures (for instance the standard design in plastic may be suitable for the air supply line from regulator to paint spray gun but will not necessarily be suitable for higher line pressures such as between compressor/supply and regulator). Applications for other fluids, including hydraulic, pneumatic, and vacuum lines are also envisaged.

One series of embodiments of the present invention focus on a swivel of simple design and which alleviates some of the problems associated with designs of the type disclosed in publication WO 01/01031A. Such preferred embodiments of this series include swivels consisting of two main parts (apart from any optional seals).

Typically the swivel includes a first part and a second part which interact with each other.

Preferably this interaction is a male to female arrangement in which one portion of the first part inserts within a portion of the second part. The relationship should also be such that once so engaged the two parts are able to freely rotate with respect to each other.

In most embodiments each part will include a sleeve portion which interacts with the sleeve of the other part. On the first part, this sleeve portion will be substantially a hollow cylinder and represent the male portion of the interaction. Conversely, the complementary sleeve portion of the second part will act as the female member of the relationship.

Preferably the outer surface of the male portion will be substantially complementary to the inner surface of the female portion. When the two portions are engaged in the assembled swivel device, the respective inner and outer surfaces will be substantially complementary to each other, as well as being substantially co-extensive one with the other. They should also lie in a close and intimate relationship one with the other. This may require some degree of precision in fabrication, as too sloppy a fit may cause problems such as leaking, excessive wear on internal surfaces, and poor rotation.

To resist longitudinal separation, respective adjacent inner and outer surfaces should be profiled to resist longitudinal separation once the swivel device has been assembled. This can be readily achieved by one or more ridges (raised portions) and complementary grooves on either or both surfaces. Ideally these should be such that the sections can be forced or pressed together for assembly. They may be designed so that an even greater force is required to separate the assembled parts. This can be readily achieved by altering the angle of incline on any provided ridges so that there is some tapering to ease insertion of the male portion into the female portion.

Furthermore, the annular ridges may act as bearing surfaces to assist rotation of each portion relative to the other. Similarly, altering the complementary profiles to differ slightly from each other can also assist in enabling rotation. Such differences may be such that surfaces of the ridge and groove may contact each other only at certain points rather than being in full contact. This results in a reduction in surface area which can help in addressing any frictional forces which in turn affects the rotation. It must be remembered that when fluid is present under pressure, there may be a tendency (depending upon the design) for the two parts of the device to be forced apart in a longitudinal direction. Hence minimising the total contact area of tapered or vertical portions which are forced against each other under fluid pressure, may assist in reducing any resulting friction affecting free rotation.

Furthermore, the presence of ridges and grooves can provide some other potential benefits including helping keep the male portion accurately aligned within the female portion—for instance forces on the hoses such as through dragging may attempt to bend or flex the swivel device. If steps are not taken to counter this, then there may be excessive rubbing and wear of internal surfaces which will eventually result in reduced ability for the two parts to freely rotate with respect to each other, and may also result in leaking of contained fluid. Such steps also help protect the seal from undue stresses leading to failure of the seal or interfering with free rotation of the parts.

Optionally provision may also be made for an internal seal. In preferred embodiments an O-ring is provided and suitable locating grooves are provided to accommodate such a seal. Multiple seals are possible. Bearings which seal may be considered.

In addition to a sleeve portion, each part will typically also contain a tail portion to which the end of the hose can be connected. This tail portion may be of a substantially conventional design such as a hollow cylinder over which the end of the hose section may be passed. This section may include ridges or other design features to help prevent a hose sliding from the tail piece. Ridges are preferably long and gently tapered to aid sliding of a hose over same, though may have a steep alternate face to resist sliding in the opposite direction, as does a barb. Provision may also be made to ensure that an external hose clamp may be fitted.

As will be discussed later, other variations of a tail piece are possible to eliminate the need for a hose clamp, or to make its use optional.

Embodiments of the present invention can be fabricated by a number of methods, and from a variety of materials. In preferred embodiments high strength injectable thermo-plastics are used. These are suitable for a variety of applications where high temperatures are not used. High temperature thermoplastics or other types of plastics may be used where higher temperature fluids are used. Again, it is considered within the skill of the average addressee of the art to choose a suitable plastic or other material suitable for the job at hand.

It is also considered that other materials other than plastics may be used—for instance metals. However, it must also be considered that some resilience or flexure of at least the female portion is generally required for insertion of the male portion. The reverse can also be considered. Most plastic materials have sufficient resilience to enable this, though the design of the various parts will also contribute to the ease of assembly. For instance, in a preferred embodiment a relatively rigid plastics material is used. There is present an angular externally protruding rib on the male sleeve portion at the end closest to the tail piece. This corresponds to an accommodating groove portion on the outermost part of the female sleeve portion. The ability of the female sleeve portion to expand during insertion of the male portion is slightly enhanced at this outermost position, as opposed to the other end of the female sleeve portion adjacent the tail piece—at this point the wall thickness is greater and more resistant to yielding so as to allow a rib to be inserted. Furthermore, locating a rib at the outer most end of the male sleeve portion would also necessitate the rib needing to be forced through substantially the entire length of the female sleeve portion, as opposed to only a short distance. Such design considerations will become of lesser or greater concern depending upon the choice of material chosen for fabrication.

If metals are used, then it may be desirable to ensure that the female portion is still constructed of a plastics or more resilient material. Alternatively either or both parts may be fabricated of metal although ideally the contacting surface of either or both sleeve portions may comprise a plastic material. This ideally should be bonded, joined or otherwise introduced to the metal at some point during the fabrication process so that essentially the swivel device still consists of only two parts.

The configuration of the two parts may also vary and there is a degree of user choice available here. In the illustrated embodiments, each of the first and second parts is substantially longitudinal and cylindrical in nature. This allows a straight through fluid path and the parts are further constructed so that the internal diameter of the channel, along which fluids travel through the swivel device, remains substantially constant.

It is possible that bends may be provided in the tail piece so that fluid may approach at various angles. For instance a 90 degree bend may be provided on one of the tail pieces. It is envisaged in such applications the device of the present invention is more likely to find use as a right angle connector although with swivel properties. This is likely to have some advantage as it can help alleviate any stress or tension on the fitting due to movement of the hoses (particularly torsional stresses), and which may otherwise result in fracture or failure of a typical right angle bend connector.

It is also possible that the present invention may be such that one or more tail pieces are split so that it can act as a T-piece or Y-connector piece. As can be appreciated other variations are possible, as well as different angles for angled connectors.

In this role as a connector, the present invention can provide improvements over traditional connector pieces. For right angle bends, T-piece and Y-piece connectors, a considerable deal of torsional stress may be placed on the connector device due to twisting and movement of the hoses—particularly if they are dragged along the ground. Such devices are also very resistant to rotation, and kinking of the hoses may be more prevalent where such types of angled connectors and joiners are used. Such modified swivels of the present invention can help address and alleviate these problems.

It can be appreciated a wide variety of different embodiments may be constructed employing the principles of the present invention. Similarly, it is possible for users to custom make connectors and joiners of their own design by merely substituting different first and second parts to assemble the final device. For instance there may be a range of differently designed first parts, and differently designed second parts (each typically one piece) which may be mixed and matched to form different swivel devices. This option need not be provided to the end user but can be used to allow manufacturers of swivel devices of the present invention to readily produce embodiments of different designs without substantially altering the manufacturing and fabrication processes. Different tail piece sections which may be connected to the first and second parts (either at a manufacturing stage or by the end user) are also envisaged. These may be screwed, clipped, or otherwise fitted to either part. These may consist of differently sized or configured tail piece protions which connect to the central first and second parts providing a swivel function.

It has been previously mentioned that some embodiments may include improvements to help retain the end of a hose position over the tail piece. It should be appreciated that these modifications may also be made to not only substantially two piece embodiment such as described above, but also other embodiments of swivels, such as those also described in publication WO 01/01031. For simplicity of the description however, reference will be made at primarily to the embodiments described above (i.e. two piece embodiments).

Modifications to help retain a hose end typically comprise the provision of a sheathed portion substantially coaxial with at least part of the length of the tail piece. While it is intended that the tail piece will typically interact with the inside wall of the hose end, the sheath will typically interact with the outer wall of the hose end. Between the two there may be a clamping action although typically either or both will include features so as to collectively act against the hose end from sliding from the swivel device.

According to one embodiment, the out surface of the tail piece may be threaded in a manner which the tail piece can be threaded into the end of the hose. This is something which is not normally possible with standard connectors as it is only the swivel allowing rotation of the device with respect to the hose which makes threading feasible—otherwise one tends to encounter problems when the second hose is screwed onto the second tail piece. Many connectors with threaded nuts require at least one nut to be separately threaded onto the connector. Additionally, many such threaded connectors run into problems when attempting to screw the device onto both hose ends. Typically difficulty is encountered when attaching the second hose end involves attempting to turn the entire hose to screw it onto the fitting. Other problems can also be encountered. A swivel according to the present invention where each tail piece may be rotated independently of the other addresses these problems.

In the case of a threaded tail piece the outer sheath may be smooth on its interior though desirably sufficiently close to the inner tail piece to squeeze the wall of the hose there against i.e. the wall of the hose end is sandwiched between the sheath and tail piece. Preferably the distance between the tail piece and sheath is not constant, and ideally the distance between the two diminishes as one travels inwardly (towards the sleeve portion) along the length of the sheath and tail piece. This will also help the arrangement to accommodate hoses of different wall thickness. By this arrangement a hose end can be firmly sandwiched between the two portions with the provided threads preventing the hosing sliding longitudinally from the tail piece. Ridges or barbs may be provided on the inner face of the sheath.

As a further modification the thread may be profiled in cross section such that the forward thread face (i.e. the face closest to the sleeve portion) is angled more acutely to the perpendicular (i.e. radial to the longitudinal axis of the tail piece) and the other face of the thread. Here the thread profile starts to resemble a barb, which will further help the thread resist longitudinal separation of the hose from the tail piece.

As a further modification a thread may be provided on the inner surface of the sheath. Similar modifications (as described in the preceding paragraph) may be made to the thread of the sheath instead of, or additionally, to such modifications being made to the thread of the tail piece. As a further alternative a thread may be provided on the outer sheath but not on the exterior surface of the tail piece, which may be smooth, have ridges (preferably gently tapering in a direction to ease insertion into a hose end), and/or barbs.

Teeth or ribs may also be provided in either of the tail piece or sheath to stop rotational movement of the hose end relative to the tail piece, in one direction only. This would allow rotation of hose end relative to tail piece in a manner enabling the hose end to be threaded onto a tail piece, though would resist rotation in the opposite direction, such as would be associated with unscrewing of the hose end.

In further variations annular barbs may be provided on either or both the inner sheath surface and the tail piece outer surface. In such cases insertion of the hose would typically be by longitudinal sliding as opposed to a screwing motion. However it is envisaged that for user convenience screwed embodiments are preferable.

### BRIEF DESCRIPTON OF DRAWINGS

Further aspects of the present invention will become apparent from the ensuing description which is given by way of example only and with reference to the accompanying drawings in which:

FIG. 1: is side diagrammatic view of the first preferred embodiment of the present invention.

FIG. 2: is cross sectional side view of an alternative embodiment of the present invention, in which one part includes one embodiment of a sheath on the tail portion.

FIG. 3: illustrates an alternative embodiment of the invention in which each tail piece includes a sheathed portion of different configuration to the above, and which drawing is illustrated in side cross sectional view,

FIG. 4: illustrates in top plan view the further alternative embodiment in which one part includes a ‘Y’ junction,

FIG. 5: shows a particular embodiment of sheath and tail piece in end cross sectional view, of thread provided on a sheath,

FIG. 6: illustrates in greater detail intermal threading on a sheath in some embodiments

FIG. 7: illustrates in greater detail the complementary groove and ridge arrangement on inner and outer sleeves in some preferred embodiments of the present invention. FIG. 8: is a cross-sectional diagrammatic view of an embodiment such as FIG. 1

FIG. 9: is an embodiment in which a sheath is included on a three piece swivel device.

FIG. 10: is a cross-sectional diagrammatic view of two further possible embodiments, and

### BEST MODES FOR CARRYING OUT THE INVENTION

With reference to the drawings, and by way of example only, FIG. 1 illustrates a preferred and simple embodiment of the present invention. This may be fabricated by injection moulding from a plastics material such as an acetyl polymer. Here the swivel device (generally indicated by arrow 1) consists of a first part (generally indicated by arrow 2) and a second part (generally indicated by arrow 3). Each part has a tail piece (generally indicated by arrows 4 and 5) and a sleeve portion (only the female outer sleeve portion (6) of the second part (3) being visible).

Each tail piece in this embodiment has a series of barbs (7) over which a hose end (not shown in FIG. 1) may be slid and subsequently fastened. Suitable fastening means include hose clamps.

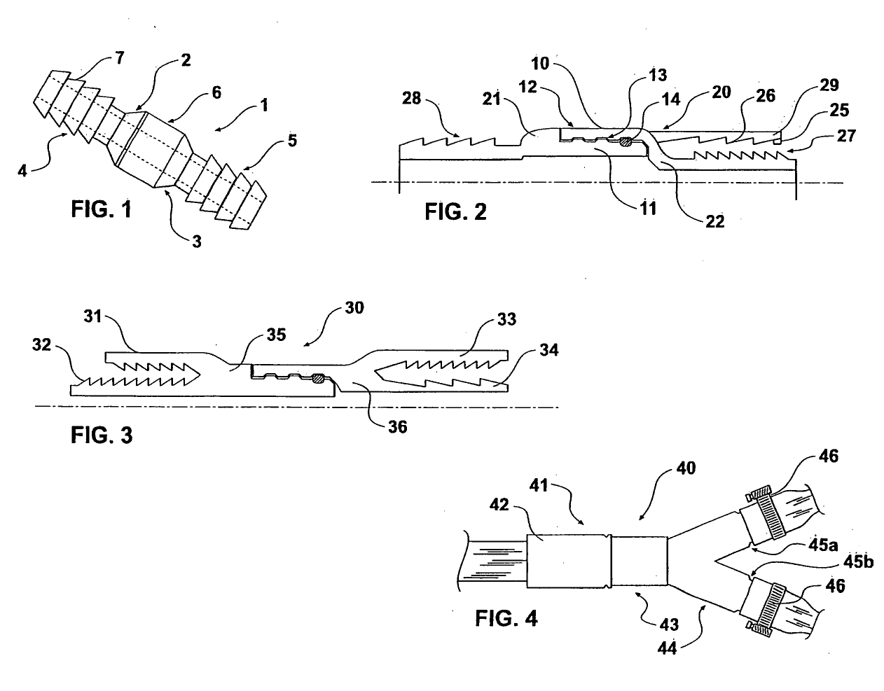

FIG. 2 illustrate in cross section an alternative embodiment sharing some similarities with embodiment of FIG. 1. The embodiment of FIG. 2 (generally indicated by arrow 20) includes first (21) and second (22) parts. The first part (21) is identical to that of FIG. 1. However while the second part (22) is similar to the second part of FIG. 1, the detail in the area of the tail piece (27) differs from that of the tail piece (7) of FIG. 1 and of the tail piece (28) of FIG. 2.

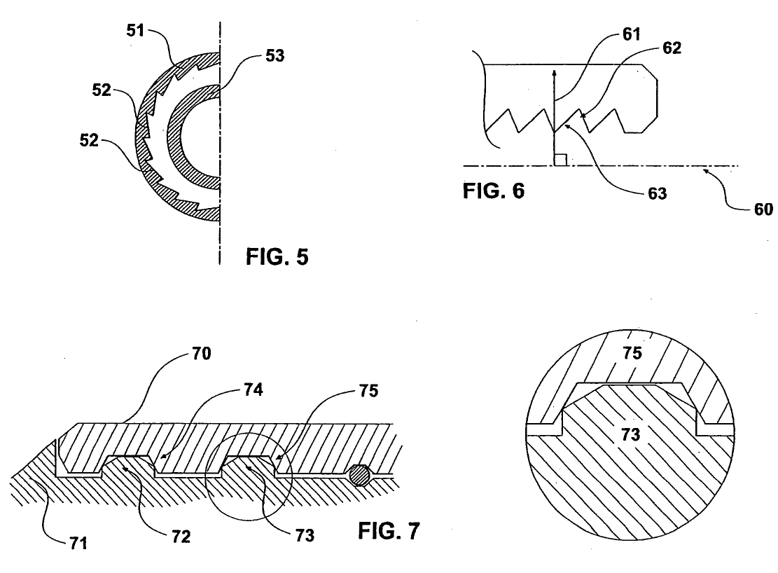

In FIG. 2 the tail piece (27) is threaded to allow the hose end to be screwed relative to second part (22) for attachment. However there is also provided an outer sheath (29) which has a series of barbs (26) similar to that provided on tail piece (28). Also present are a series of radially distributed barbs (25) which are better illustrated in FIG. 5 (see later). In the central sleeve portion the second part (22) is provided with an outer sleeve portion (10) while first part (21) is provided with an inner sleeve portion (11). There is provided complementary ridge and groove sets (12, 13) distributed annularly about the sleeves (10, 11). Grooves are also provided for an O-ring (14 to act as a sealing member. These arrangements of ridges and grooves help locate the two parts (21, 22) with respect to each other and also help seal (to a limited extent) the device against fluid seepage or the ingress of foreign material.

Each part (21, 22) is manufactured as a separate unit and they are assembled into a final device (20) by push fitting the sleeve portions appropriately. They are ideally precision made to resist bending of the parts (from their longitudinal axis) as a consequence of pulling on a hose. This helps avoid undue wear on the seals and other internal contact points.

FIG. 3 illustrates an alternative embodiment in which the sheath and tail piece portions (31/32, and 33/34) differ. On the first part (35) both the sheath (31) and tail piece (32) are threaded and as, for the majority of other sheaved embodiments, the distance between the sheath (31) and tail piece (32) diminishes as one travels inwardly towards the sleeve portion.

For the second part (36), its sheathed portion (33) is threaded while barbs are at present on the tail piece (34).

In FIG. 4 there is illustrated an embodiment in which there is present on the first part (41) a sheath (42). The configuration adopted it may be that of either of FIGS. 2 or 3, or other possible arrangements are envisaged within the scope of this invention.

The tail piece (44) of the second part (43) splits (or combines) fluid flow into two arms. In this illustrated embodiment the tail piece section (45a,b) has barbs similar to the tail piece (28) illustrated in FIG. 2. Hose clamps (46) are provided.

FIG. 5 illustrates one particular embodiment of a sheathed arrangement in end view. Here on the outer sheath (51) can be seen a series of annularly directed barbs (52) which facilitate rotation of an inserted hose end in one direction but which resist rotation in the other direction. Typically the inner tail piece would be threaded such that the barbs (52) allow the tail piece (53) to be screwed into the hose end but will resist unscrewing.

FIG. 6 illustrates the thread on a sheath in closer detail. Illustrated is longitudinal axis (60) and a ray (61) perpendicular thereto. As can be seen a first face (62) of each thread is angled more closely to the perpendicular (61) than the alternate face (63). This modification is optional and has been exaggerated in FIG. 6. However as can be appreciated, the thread in this case is also acting as a barb to resist outward longitudinal removal of the hose end from the tail portion. A similar modification may also be made to a thread present on a tail piece.

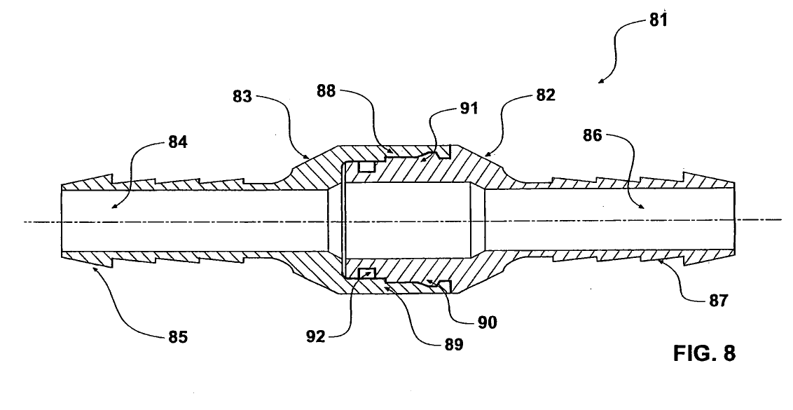

FIG. 7 illustrates in more detail the sleeve portions (70, 71). Here it can be seen that each ridge portion (72, 73) contacts its complementary groove portion (74, 75) preferentially only at a few points. This can be achieved by the ridge and grooved portions having slightly different profiles, as can be seen in the enlargement of ridge (73) and groove (75). Different profiles may be adopted and this type of modification need not be present on all embodiments of the invention. However, this modification (which is greatly exaggerated in the enlargement) can help reduce friction which may result as a consequence of internal fluid pressure attempting to force the sleeve portions (70, 71) apart.

With respect to FIG. 8 there is illustrated a swivel device generally indicated by arrow 81. The coupling is made from two main parts, a male portion 82 and a female portion 83. The female portion 83 has a tail piece 84 which includes a number of barbs 85. The male portion 82 has a similar tail piece 86 with barbs 87.

The female portion 83 has an internal surface 88 which in combination with the external surface 89 on the male portion 82 acts a swivel bearing for the device 81. This is achieved by having the external surfaces of the male portion 82 and the female portion 83 substantially complementary and symmetrical around a central axis allowing the two parts to swivel substantially unrestricted with respect to each other.

An outwardly extending flange portion 90 on the male portion 92 fits into a complementary groove 91 on the female portion 83. This, coupled with slight deformation of the material from which the coupling 81 is made provides a locking mechanism by which the two parts are held with respect to each other. The applicant has found that this is sufficient to prevent the coupling from coming apart when used with garden hoses.

The male portion 82 has an indentation into which is fitted a seal in a form of an O-ring 92. The O-ring 92 prevents fluid from leaking out from the connector 91 when water is present under pressure. The O-ring 92 is also sufficiently configured so that it does not prevent the swivel movement of the coupling with respect to each other and assists in holding the male and the female portions with respect to each other.

It is envisaged that the ends of the male and female portions distal to the interconnecting ends are configured to allow the ready attachment of hoses and conduits to those portions. While a number of connecting configurations are envisaged, in preferred embodiments these come in the form of barbs. Flexible conduits such as garden hoses can be pushed over the barbs which act to hold the hose relative to the coupling.

Preferably, the coupling includes a seal such like an O-ring which when the male and female portions are coupled the O-ring fits between the outer surface of the male portions and the inner surface of the female portions. However, the seal must also not sufficiently impede the rotation of the male portion relative to the female portion and thereby interfere with the swivel movement. Thus, it is envisaged that either the male or the female portion may have an indentation which can fit the seal so only a small surface of the seal is exposed between the two portions.

Finally, it would be desirable if the seal could also assist in preventing the two halves of the coupling from being pulled apart once coupled, this making a more secure connection.

FIG. 10 illustrates a three piece embodiment according to or similar to that of WO 01/01031 in which one sheath 112 is connected to the third locking element. Either or both sheath (112) and tail piece(111,113) (at each end) may be threaded. For simplicity threads and barbs have been omitted from this view.

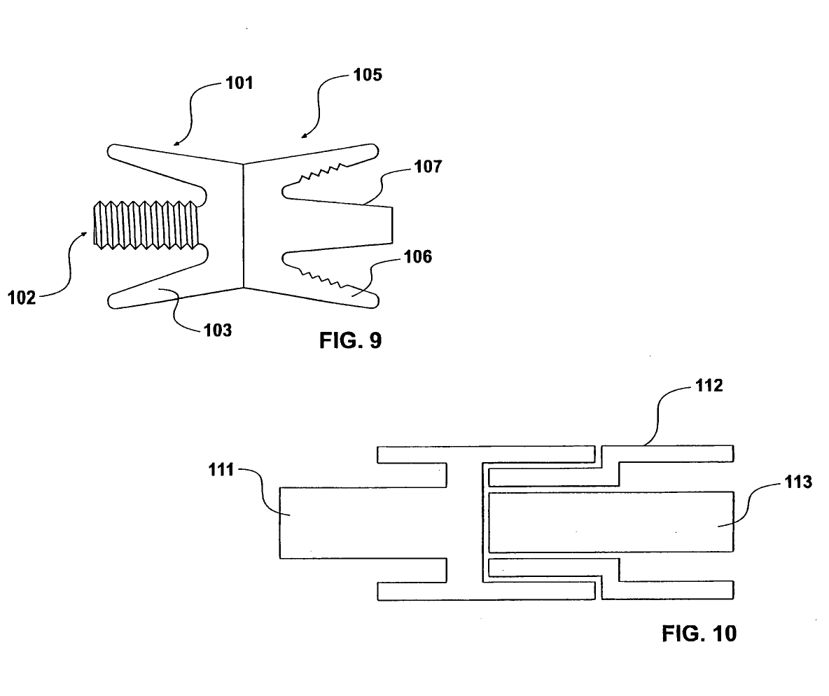

FIG. 9 illustrates another embodiment. Here one end (101) illustrates a threaded tailpiece (102) while the outer sheath (103) is substantially smooth on its inside. It may be partially resilient in design and/or material of fabrication to apply a continual bias of a tightly inserted hose end against the tail piece (102). The other end (105) has an internally threaded sheath (106) with substantially smooth tail piece (107). This may be slightly tapered towards its end, or substantially straight and parallel to the longitudinal axis.

As can be appreciated a number of variations of the present invention exist and not all have been illustrated herein. It is anticipated that skilled addressees of the art would be able to take the principles discussed herein and apply them in the manufacture of different embodiments falling within the envisaged scope of this invention.

The term ‘comprising’ where used herein is intended to be used in its broadest sense and is not intended to exclude other possible components from being considered as part of a combination.

The background art description represents the inventors understanding of the problems and considerations forming part of the development of its invention and is not intended to necessarily represent an admission of prior art.

Aspects of the present invention have been described by way of example only and it should be appreciated that modifications and additions may be made thereto without departing from the spirit or scope thereof as defined in the appended claims.

The claims defining the invention are:

1. A swivel including first and second parts, each possessing a tail portion for the connection of a hose, and each part also possessing substantially distal to the tail portion a sleeve portion; the sleeve portion of said first part being an inner sleeve interacting in a male-to-female relationship with the sleeve portion of said second part which acts as an outer sleeve; and when said sleeve portions are engaged the outer surface of said inner sleeve being substantially co-extensive and in intimate relationship with the inner surface of said outer sleeve; said sleeves being able to rotate freely with respect to each other about their longitudinal co-axis; said surfaces being configured to interact with each other to resist longitudinal separation.

2. A swivel as claimed in claim 1 in which the co-extensive sleeve surfaces are profiled to include complementary ridges and grooves which resist longitudinal sliding of one sleeve portion with respect to the other.

3. A swivel, as claimed in claim 2, in which the complementary ridges and grooves are configured to allow each sleeve portion to be forced longitudinally in a first direction allowing assembly of the two parts.

4. A swivel, as claimed in any one of the preceding claims, in which the swivel resists leaking of fluid from the sleeve portions.

5. A swivel, as claimed in claim 4, in which the swivel is resistant to leakage from the sleeve area for water at pressures of up to at least 300 kPa.

6. A swivel, as claimed in claim 4, in which the swivel is resistant to leakage from the sleeve area for water at pressures of up to at least 700 kPa.

7. A swivel, as claimed in any one of the preceding claims, which also includes at least one seal member.

8. A swivel, as claimed in claim 7, in which a said seal member is an O-ring.

9. A swivel, as claimed in any one of the preceding claims, in which in the assembled swivel the hollow portions define a bore for the flow of fluid through the swivel.

10. A swivel, as claimed in claim 9, in which the internal bore is substantially straight.

11. A swivel, as claimed in any one of the preceding claims, in which the tail portions are directed substantially longitudinally.

12. A swivel, as claimed in any one of the preceding claims, in which a tail portion consists of a substantially cylindrical portion which is configured on its outside to resist sliding movement of a hose there along, in at least one longitudinal direction.

13. A swivel, as claimed in claim 12, in which said cylindrical portion is substantially smooth over the majority of its outer surface.

14. A swivel, as claimed in either claim 12 or claim 13, in which the substantially cylindrical portion includes ridges, and which ridges may be barbs preferably of shallow incline and height.

15. A swivel, as claimed in claim 14, in which the ridges are profiled to assist sliding of a hose over the outside of the cylindrical portion in one direction, but resist sliding in the opposite outward direction.

16. A swivel, as claimed in any one of claims 12 through 15, in which the outside of the substantially cylindrical portion is threaded.

17. A swivel, as claimed in any one of claims 12 through 16, in which the outside of the substantially cylindrical portion includes ridges and/or barbs resisting rotation of a hose with respect to the cylindrical portion in one direction, said rotational direction being that of unscrewing of the hose from the cylindrical portion.

18. A swivel, as claimed in any one of claims 12 through 17, in which the part on which a substantially cylindrical portion is located includes an outer sheath for the end of an attached hose, the inner surface of said sheath being radially distanced from the outer surface of said cylindrical portion, said distance being commensurate with the wall thickness of a typical hose to be connected.

19. A swivel, as claimed in claim 18, in which said radial distance between the sheath and cylindrical portion diminishes as one travels inwardly along the tail portion towards the sleeve portion.

20. A swivel, as claimed in either claim 18 or claim 19, in which the inside of the sheath portion is threaded.

21. A swivel, as claimed in claim 20, in which for an internally threaded sheath portion, the outside of the substantially cylindrical portion includes ridges and/or barbs resisting rotation of a hose with respect to the cylindrical portion in one direction, said rotational direction being that of unscrewing of the hose from the cylindrical portion.

22. A swivel, as claimed in any one of claims 16 through 21 when dependent upon claim 16, in which for an externally threaded cylindrical portion, the inside of the sheath portion includes ridges and/or barbs resisting rotation of a hose with respect to the cylindrical portion in one direction, said rotational direction being that of unscrewing of the hose from the tail portion.

23. A swivel, as claimed in any one of claims 18 through 22, in which both sheath (where present) and cylindrical portion include ridges, barbs and/or protuberances resisting removal of a hose from a tail portion once connected.

24. A swivel, as claimed in any one of the preceding claims, in which the sleeve portion of at least one of the parts substantially has radial symmetry about substantially all points along the longitudinal axis of the sleeve portion.

25. A swivel, as claimed in any one of the preceding claims, in which the wall thickness of the sleeve portion of at least the first part, including the inner sleeve portion, is sufficient to resist any flexing in a radial direction.

26. A swivel, as claimed in any one of the preceding claims, in which the wall thickness of the outer sleeve, of the second part, in combination with the positioning of complementary ridges and grooves, and material of construction, is such that there is sufficient flexure and/or resilience to allow the outer sleeve to be slid over the inner sleeve for assembly.

27. A swivel, as claimed in any one of the preceding claims, in which at least one of the parts is fabricated substantially of a plastics material.

28. A swivel, as claimed in claim 27, in which said plastics material possesses at least one of the following properties: UV-resistant, non-brittle, of high tensile strength (to resist any flexing more than necessary for assembly), and rigidity.

29. A swivel, as claimed in either claim 27 or claim 28, in which at least one of the two parts is fabricated by injection moulding.

30. A swivel, as claimed in any one of the preceding claims, in which a tail portion is configured to allow connection of a hose or conduit at an angle to the main longitudinal axis of the swivel.

31. A swivel as claimed in claim 30 in which the angle is substantially perpendicular to the main longitudinal axis of the swivel.

32. A swivel as claimed in any one of the preceding claims in which either said first or second part is configured to allow connection of more than one hose or conduit thereto.

33. A swivel as claimed in claim 32 in which said hoses or conduits are configured, when attached, in substantially a ‘Y’ or ‘T’ arrangement with the body of the swivel.

34. A swivel as claimed in any one of claims 30 through 33 in which the configurations of the tail portions of the first and second parts, with respect to either or both the number and angle of inclination of connected hoses or conduits, are different.

35. A swivel comprising at least a first part and a second part; said first part comprising substantially a hollow cylindrical length, one end comprising a tail portion configured to accept the end of a hose for connection, and the other comprising an inner sleeve portion acting as the male member in a male-female connection relationship, the second part comprising also a substantially hollow cylindrical length in which one end comprises also a tail portion, but wherein the other comprises an outer sleeve portion acting as the female member in a male-female connection relationship, wherein upon assembly the inside of the female sleeve is in close intimate relationship with the outside of the male sleeve portion, the two sleeve portions being able to freely rotate with respect to each other, though include complementary profiling to resist longitudinal separation due to internal fluid pressure.

36. A swivel, as claimed in claim 35, in which an internal bore defined by the hollow internal portions for the flow of fluid is of substantially constant cross-section.

37. A component consisting of said first part, or second part, or part thereof for use in the assembly of a swivel as claimed in any one of claims 1 through 36.

38. A component as claimed in claim 37 in which the tail portion allows for either or both of: (i) attachment of a hose or conduit at an angle to the main longitudinal axis of the assembled swivel, and (ii) attachment of multiple hoses or conduits at an end of the assembled swivel.

39. A component as claimed in claim 38 which is separable into further subcomponents at least one of which includes a tail portion for the connection of a hose or conduit.

40. A hose and swivel combination consisting of hoses connected to a swivel as claimed in any one of claims 1 through 36.

41. A method for reducing the tendency of flexible hoses to kink consisting of inserting at least one swivel, as claimed in any one of claims 1 through 36, into a length of said flexible hose.
